(19) United States
(12) Patent Application Publication
(10) Pub. No.: US 2005/0181952 A1
(43) Pub. Date: Aug. 18, 2005

(54) Slow-release agrochemicals dispenser and method of use

(75) Inventors: Michael Burnet, Tubingen (DE); Fred Kanampiu, Nairobi (KE); Jonathan Gressel, Rehovot (IL)

Correspondence Address: PALMER & DODGE, LLP;KATHLEEN M. WILLIAMS, 111 HUNTINGTON AVENUE, BOSTON, MA, 02199, US

(73) Assignee: Hi-Cap Formulations Ltd.

(21) Appl. No.: 11/028,014

(22) Filed: Jan. 3, 2005

Related U.S. Application Data
(63) Continuation-in-part of application No. PCT/US03/20966, filed on Jul. 3, 2003.
(60) Provisional application No. 60/393,481, filed on Jul. 3, 2002.

(51) Int. Cl. A01N 25/26; A01N 25/28

(52) U.S. Cl. 504/359

(57) ABSTRACT

Acetolactate synthase inhibitors, such as imazapyr and pyrithiobac and mixtures thereof, prepared as slow-release formulations are useful for the preparation of seed dressing, seed priming, seed or particle-substrate coating herbicidal compositions for control of parasitic weeds such as Orobanche spp., Striga spp. and Alectra spp. The use of agrochemicals can be rendered more efficient when coated or bound as a slow release formulation. Particles used as the substrateto be coated may be plant seeds or particles made of a strong or weak ionic resin or a biodegradable carbohydrate natural polymer, a modified polymer, or artificially lignified cellulose. The herbicidal formulation may be covalently linked or adsorbed to the surface of the particle. The same slow release formulations are invaluable for preventing rapid herbicide leaching in agricultural as well as non-agricultural weed control situations.

### RELATED APPLICATION(S)

This application is a continuation-in-part of International Application No. PCT/US2003/020966, which designated the United States and was filed on Jul. 3, 2003, published in English, which claims the benefit of U.S. Provisional Application No. 60/393,481, filed on Jul. 3, 2002. The entire teachings of the above application(s) are incorporated herein by reference.

### FIELD OF THE INVENTION

This invention relates to the composition and method of use of slow-release agrochemical dispensers, particularly useful for dispensing herbicides to control parasitic weeds, or other weeds germinating or growing in close proximity to the crop, or for preventing leaching of herbicide in general weed control situations.

### BRIEF DESCRIPTION

This invention relates in general to the use of agrochemical coated particles, including particles made of strong or weak ionic resin and slow-release formulations of agrochemicals covalently-bound to particles made of a biodegradable carbohydrate, such as natural or artificially lignified cellulose, natural or chemically modified starch, plant seeds, other propagules and/or soil for the control of weed growth in agricultural or planting soils where residual activity without crop phytotoxicity is needed, as well as rights of way or industrial sites.

### BACKGROUND OF THE INVENTION

Parasitic weeds infest grain crops and legumes by attaching themselves to the roots of a host crop and sending signals to the host plant that results in a flow of nutrients to the parasite rather than the crop plant itself These weeds can either be holoparasites, i.e. plants totally lacking the capacity to produce nutrients for themselves, e.g. Orobanche spp. (common name: broomrapes), or hemiparasites, i.e. they can perform photosynthesis for parts of their life cycles (e.g. Cuscuta spp. (dodders), Striga spp. (witchweeds) and Alectra spp.), but derive much of their organic nutrition, water and minerals from the host plants. The Cuscuta spp. attach to stems and grow above ground, the others attach to roots and spend much of their life cycle below ground until a flower stalk emerges from the soil. Parasitic weeds suck up the crop's energy and also much of the soil's nutrients. As a result, the crop withers while the parasites grow very well, producing more seed to infest the next crop that is planted in the agricultural fields. One of the major modes of dissemination of parasitic weeds is by contamination of crop seed. Half of the seedlots sampled in local African markets by Bemer et al., 1994 were contaminated with Striga seeds. Orobanche seeds stick to crop seeds and arduous procedures are required to remove them so as not to infest uninfested fields. Thus, a good general topical disinfectant is needed for inactivating parasitic weed seeds in contaminated seedlots prior to sowing. Additionally, there is also a general need for ridding crop seed of other contaminating non-parasitic weed seeds.

Parasitic weeds are a scourge threatening 4% of cropland worldwide, infecting all grains cultivated south of the Sahara (witchweeds=Striga spp) and vegetables, legumes and sunflowers (broomrape=Orobanche spp.) in the Mediterranean, including Israel. The yield loss (on the average) is more than 50% in the infested fields. Till recently there were few selective herbicides capable of controlling the root parasitic weeds while they are still underground, perpetrating their damage.

It has been shown that a foliar application of glyphosate to transgenic plants produced from the species of the plants discussed above allows the systemic inactivation of parasitic weeds (Joel et al., 1995), as had been predicted earlier (Gressel, 1992). It has also been shown that soil-active herbicides can be applied, at very low rates, to seeds of cowpeas, known to be capable of degrading particular soil-active herbicides, in order to control parasitic Striga. Striga has also been controlled at much higher rates in maize with biotechnologically-derived resistance to the same groups of soil-active herbicides (Ransom et al., 1995). Seeds of mutant or transgenic crops bearing a very large magnitude of resistance such that they can withstand high local concentration of herbicides, such as herbicide-resistant maize (corn) or other crops, can be coated with or soaked in, water-soluble herbicidal formulations before planting as an attempt to control parasitic weed growth (Kanampiu et al. 2001, and U.S. Pat. No. 6,096,686), especially of parasitic weeds such as Striga. However, soil column experiments show that much of the water-soluble herbicide moves through the soil profile more rapidly than maize roots grow through the same profile. Thus, much of the herbicide is lost to the control of the parasitic weeds; allowing the parasites to attack late in the season when crop roots grow into soil devoid of herbicide due to the rapid leaching. In addition, there can be the problem of the leaching of unused herbicide into ground water.

### SUMMARY OF THE INVENTION

The present invention relates to the composition and method of use of coated particles and/or seeds, as slow-release agrochemical dispensers. In particular as slow-release herbicide dispensers to control the growth of parasitic weeds that infect agricultural crops The particles may be beads of biodegradable material such as cellulose or slowly hydrolysable material such as artificially lignified cellulose to which a herbicide made be covalently bound to the exterior of the bead to form a coating. Additionally, the biodegradable material may be natural starch or chemically modified starch.

In another embodiment the particles may be beads of charged resins, preferably weak or strong ionic resins that bind charged herbicides or other agrochemicals by strong ionic interactions.

In another embodiment, the particles are plant seed, which are coated with the herbicide. The plant seed would normally be a viable, agricultural crop such as maize or other grain, legumes, vegetables, and oil-seed crops such as sunflowers. Additionally, the seed may be from a transgenic or mutant plant that is resistant to the herbicide applied to the outside of the seed.

As an additional embodiment, the herbicide used, is a slow-release formulation of acetolactate synthase (ALS) inhibitors, imazapyr or pyrithiobac.

### DETAILED DESCRIPTION OF THE INVENTION

Slow release formulations of fertilizers, pesticides (including herbicides, Schreiber et al., 1987) and drugs (Anand et al., 2001) are common (see reviews, Lewis and Cowsar, 1977, Patwardhan and Das, 1983), yet there are no reports of applying such formulations to crop seeds. There are several distinct types of slow release formulations that are appropriate for molecules such as the herbicides imazapyr and pyrithiobac and other ALS-inhibitor herbicides, even those that have been shown to be slightly phytotoxic to maize, (Abayo at al., 1998), including:

1) Covalent binding to a matrix that is either biodegradable or where the covalent linkage is slowly hydrolyzed. Anionic herbicides that act on pests by a different mechanism such as 2,4-D have been bound to starch cellulose, and dextrans by such technologies, (Diaz et al., 2001, Jagtap, et al., 1983, and Mehltretter et al., 1974).

2) Strong, non-covalent interactions with special matrices. Various slow release formulations of pharmaceutical preparations have been developed by such means for pharmaceuticals, (Anand et al., 2001), but we have not found reports of their use for slow release of herbicides.

The release of bound material from the two types of formulation described above can be further modulated by micro encapsulation technologies that further control the rate of release, (Schreiber et al., 1987, Tefft and Friend, 1993). Seeds have never been reported to have been used as carriers for slow release formulations of herbicides, nor for the insertion of slow release herbicide formulations into the soil, except in the case of glyphosate with our own technology where it was proposed to form insoluble salts of glyphosate to slow its release into the seed (not into the soil, where it would rapidly be inactivated). While seeds have been considered as carriers for herbicides, they have not been used extensively until the advent of transgenic crops bearing a very large magnitude of resistance such that they can withstand the high local concentration of herbicide. The two lines of research have suggested that the dressings as used above, represent an inefficient use of herbicides.

1) In pot experiments, Berner et al., 1994, were able to use far less herbicide than is required in the field. We now presume that the reason for this conundrum is that pots are rarely watered in such a manner to wash out the solutes (including in this case herbicide). Thus all the herbicide remained in the root zone.

2) We have recently found, in soil column experiments, that the herbicide imazapyr moves more rapidly through to the soil profile than roots grow through the same profile. Thus, much of the herbicide is lost to the control of parasitic weeds; allowing the parasites to attack late in the season when crop roots grow beyond where herbicide had moved through and killed parasite seeds (Kanampiu et al. 2002). As herbicide moves systemically through the root zone, there is reason to have it slowly available throughout the season. A bound, slow release compound is a way to accomplish this. In addition, if less herbicide can be used, there is less potential for contamination of ground water by unused herbicide.

The methods and details of U.S. Pat. No. 6,096,686 are incorporated by reference into this application. In addition, concentration of herbicide solutions and other non-novel details are incorporated into this application from the articles by Kanampiu et al., 2001, 2002, 2003.

Slow Release Formulations

There are two distinct types of slow release formulations for molecules such as the herbicides imazapyr and pyrithiobac (both anionic herbicides, with complementary cation, that is itself, usually of little importance).

1) Covalent binding to a matrix that is either biodegraded or where the covalent linkage is slowly hydrolyzed. Anionic herbicides such as 2,4-D have been bound to starch cellulose, and dexterous by such technologies (Diaz et al., 2001, Jagtap, et al., 1983, and Mehltretter et al., 1974).

2) Strong ionic interactions with ion exchange matrices. Various slow release formulations of pharmaceutical preparations in medicine (Arand et al., 2001) but we have not found reports of their use for slow release of herbicides. The use of weak ionic interactions to bind herbicides to chemically modified montmorillonite clays has been reported (Mishael 2002a, b), but these modified clays have too low an exchange capacity to be practical (The exchange capacity is 50 times less than is described below in this patent, meaning that 50 times more material would have to be used.

The release of bound material from the two types of formulation described above can be further modulated by micro-encapsulation technologies that further control the rate of release (Schreiber et al., 1987, Tefft and Friend, 1993).

Seeds have never been reported as a carrier for slow release formulations of herbicides, nor for their insertion into the soil, except in the case of glyphosate, where it was proposed to form insoluble salts of glyphosate to slow its release into the seed (not into the soil, where it would rapidly be inactivated (Gressel and Joel, 2000).

We demonstrate that by coating seeds with slow release formulations of herbicides and planting them into the soil, that it is possible to achieve longer control of parasitic weeds, with less herbicide, than by previous technologies using previously used and novel synthesis strategies for herbicides.

### EXAMPLES

### Example 1

### Synthesizing Slow Release Formulations of Imazapyr and Pyrithiobac with a Strong Anion Exchange Resins, with Free Herbicide to Have Both Immediately Available and as Slow Release Material

Pyrithiobac sodium was provided by the manufacturer, Kumiai, Ltd., Japan. Imazapyr acid was prepared from surfactant-formulated isopropylamine salt of imazapyr (Arsenal™). It was diluted with an equal volume of acetone and the pH of the solution decreased with concentrated HCl to the pKa of imazapyr (3.6). Imazapyr crystals formed (while the surfactant was retained in solution by the acetone). The crystals were poured onto filter paper in a Buchner funnel and vacuum was applied. The crystals were washed with acetone until no blue color of the formulant remained. The crystals were air-dried in the fume hood. Comparison of the UV adsorption spectrum of this material against that of an analytical standard (Riedel-de Haën, Pestanal grade) showed >98% purity.

The slow release formulations of imazapyr were prepared such that half of the imazapyr was bound and half was free. One formulation has the imazapyr tightly bound to Dowex 2 anion exchange resin (Dow Chemical Company, Midland Mich., USA) and the other to DEAE (diethylyaminoethyl) cellulose (Whatman DE-52—Whatman Ltd, Maidstone, Kent, UK). The formulations contain 33% imazapyr (i.e. 16.5% bound, 16.5% free and were prepared as follows: 2 g Dowex 2 (capacity 1 meq/g) was suspended in large excess 1 N NaOH 30 min., washed into column and eluted with water overnight, put in mortar and pestle with excess water; likewise 2 g Whatman DE52 (capacity 1 meq/g) put dry in a mortar and pestle. In each case 1 g imazapyr acid was added, in latter case first ground dry, and then with excess water. The slurries were sporadically ground in both cases over an hour. The mortars were covered with miracloth and put in vacuum oven at 60 degrees overnight, powdered, and used to coat the seeds as described in example 2.

The slow release formulations of pyrithiobac were prepared in a manner similar to above, such that half of the pyrithiobac was bound and half was free. One formulation has the pyrithiobac tightly bound to Dowex 2 and the other to DEAE Cellulose. The formulations contain 38.5% pyrithiobac. (This is because pyrithiobac acid has a 25% higher molecular weight than imazapyr acid). 2 g Dowex 2 (capacity 1 meq/g) suspended in large excess 1 N NaOH 30 min., washed into column and eluted with water overnight, put in a mortar and pestle with excess water; likewise 2 g Whatman DE52 (capacity 1 meq/g) put dry in a mortar and pestle. In each case 1.25 g pyrithiobac acid added, in latter case first ground dry, and then with excess water. The slurries were sporadically ground in both cases over an hour, the mortars covered with miracloth and put in vacuum oven at 60 degrees overnight, powdered, and used to coat the seeds as described in example 2.

### Example 2

### Efficacy of Slow Release Formulations Containing Free Herbicide on Striga Control on (ALS)-Resistant Mutant Maize

The herbicide resistant maize variety was produced as follows:

A partially to more fully tropical adapted open-pollinated synthetic maize variety, ‘CIMMYT Tropical-IR’ was used in all tests. This variety, used during the final stages of selection breeding, was advanced from a BC₀F₃ cross of IR donor Pioneer hybrid 3245IR and ZM503 (INT-A/INT-B) initially made in 1996 in Zimbabwe. ZM503 is a full vigor varietal cross, developed by CIMMYT in Zimbabwe with good adaptation for the mid-altitude environments of eastern and southern Africa. The best initial BC₀F₁'s were sprayed with herbicide and selfed to obtain S₁ ears. The S₁ seeds were planted ear-to-row, sprayed with herbicide and resistant plants were self-pollinated to obtain S₂s. The S₂ seeds were planted ear-to-row. Imazapyr (75 g ae ha⁻¹) as 25% Arsenal™, was applied over the top to maize plants at 8-10 leaf stage for selecting homozygous families. The remaining resistant plants were self-pollinated to obtain S₃ ears. Seeds from the best 151 S₃ ears were planted ear-to-row and recombined by half-sib pollinations to form the F₁ generation of ‘CIMMYT Tropical-IR’ in 1998. The F₂ and subsequent variety maintenance has been carried out by bulking hand-pollinated, full-sib ears.

A solid coat of polylvinylpyrollidone (PVP) (avg. MW 90 Kd) was used to bind the various formulations to the maize seed. 90 mg of PVP mixed with 2.9 ml water was combined with various amounts of the slow release formulations described in Example 1 or with 36 mg dry imazapyr (acid form) or sodium pyrithiobac powder mixed thoroughly together and then with 144 maize seeds (to give a imazapyr coating of 0.25 mg a.e. imazapyr seed⁻¹). This is the equivalent of 13.25 g a.e. ha⁻¹, respectively, when planted in the field at 53,300 seeds ha⁻¹. The treated seeds were then planted in the field within 2 days of coating. All field experiments were conducted at the National Sugar Research Center (NRSC) of the Kenya Agricultural Research Institute (KARI) near Kibos (0°04′S, 34°48′, elevation 1214 m) in western Kenya. The soil is classified as a vetro-eutic planosol according to the FAO/UNESCO (1974) system. The fields used had previously been cropped to maize that was heavily infested with Striga, which matured and seeded the area. The experiments were carried out during October-January 2000/2. Seasonal precipitation during that season was 550 mm. Treatments were arranged in a randomized complete block design with three replicates for each experiment. Experimental units consisted of four 3-m long rows with 75 cm between rows. Two maize seeds were planted per hill within these rows, with hills spaced at 50 cm. Striga seeds were added to each plot to ensure that each maize plant was exposed to a minimum of 2,000 viable Striga seeds. These seeds were added in a sand/seed mixture and placed in an enlarged planting hole at a depth of 7-10 cm (directly below the maize seed) as well as in a 7-10 cm deep furrow parallel to the planting holes. At planting, 50 and 128 kg N and P₂O₅ ha⁻¹, respectively, were applied in the form of di-ammonium phosphate (18-46-0) to ensure reasonable maize development.

The maize hybrid used in the field is highly susceptible to pest problems in tropical Africa. Thus, maize was treated to preclude insect and disease problems with 100 mg a.i. carbofuran insecticide hill⁻¹ (2.65 kg a.i. carbofuran ha⁻¹) at planting, and sprayed with 770 g a.i. ha⁻¹ endosulfan, and a mixture of the 225 g a.i ha⁻¹ metalayxl and 1.68 kg a.i. ha⁻¹ mancozeb fungicides at two and eight weeks after planting.

Data were collected from the two inside rows excluding the end plants. Maize stand counts were determined six weeks after planting. Striga counts were made every two weeks beginning six weeks after planting when Striga began to emerge, and ending at harvest fourteen weeks after planting. The number of flowering Striga plants and Striga seed capsules at twelve and fourteen weeks; adjusted grain yield to 15% moisture; and total maize shoot dry weight were all measured.

The results of the first experiment with imazapyr are shown in (Table 1). The results indicate that the slow release formulations using CE52 Whatman CE 52 formulation of DEAE and DX1 (Dowex 1 anion exchange resin) are effective against Striga infestation during a long growing period. Striga control was better at the lowest rate of CE52 and DX1 than with the same rate of unbound herbicide immediately available, suggesting that far less or no herbicide needs to be immediately available and all can be in slower release formulation.

TABLE 1
Effect of slow release of imazapyr on Striga emergence, 2001/2002

| Imazapyr | Total | Available imazapyr | | | | | | | | |
|---|---|---|---|---|---|---|---|---|---|---|
| and | available | Immediately | Slow | Striga emergence (m⁻²)^{a} | | | | | Striga m⁻²14 weeks | |
| carrier | imazapyr | release | | Weeks after planting | | | | | after planting | |
| mg/seed | mg/seed | (g ha⁻¹) | | 6 | 8 | 10 | 12 | 14 | Flower | Capsules |
| 0 | 0 | 0 | 0 | 1.15a | 2.67a | 9.78a | 17.33a | 23.73a | 8.00a | 14.22a |
| 0.125 | 0.125 | 6.63 | 0 | 0.0b | 0.0b | 0.18b | 1.33b | 2.93b | 0.27b | 0.0b |
| 0.25 | 0.25 | 13.25 | 0 | 0.0b | 0.0b | 0.0b | 0.0b | 0.09b | 0.0b | 0.0b |
| 0.5 | 0.5 | 26.5 | 0 | 0.0b | 0.0b | 0.0b | 0.18b | 0.45b | 0.0b | 0.0b |
| 0.75 DE-52 | 0.25 | 6.63 | 6.63 | 0.0b | 0.0b | 0.0b | 0.36b | 0.80b | 0.0b | 0.0b |
| 0.75 DX1 | 0.25 | 6.63 | 6.63 | 0.0b | 0.0b | 0.0b | 1.25b | 3.38b | 0.17b | 0.0b |
| 1.5 DE-52 | 0.5 | 13.25 | 13.25 | 0.0b | 0.0b | 0.0b | 0.0b | 0.09b | 0.0b | 0.0b |
| 1.5 DX1 | 0.5 | 13.25 | 13.25 | 0.0b | 0.0b | 0.0b | 0.35b | 2.31b | 0.0b | 0.0b |
| LSD_{0.05} | | | | 0.04 | 0.87 | 0.50 | 2.62 | 4.59 | 1.11 | 1.56 |

### Example 3

### Synthesizing a Slow Release Formulations of Imazapyr Bound to Anion Exchange Resins without Free Herbicide

Slow release formulations of imazapyr were prepared to the maximum exchange capacity of the anionic binders such that all imazapyr is bound. One formulation has the imazapyr tightly bound to Dowex 2, with the other lightly less tightly bound to DEAE Cellulose. They have been lyophilized down. The formulations contain 20% imazapyr (i.e. 20 mg imazapyr per 100 mg powder.

4 g Dowex 1 (similar to Dowex 2) (capacity 1 meq/g) was suspended in large excess 1 N NaOH 30 min., washed into column and eluted with water overnight, put in mortar and pestle with excess water; likewise 4 g Whatman DE52 (capacity 1 meq/g) put dry in mortar and pestle with excess water. In each case 1 g imazapyr acid added, in the latter case first ground dry, and then with excess water. The slurries were sporadically ground in both cases over an hour. The mortars were covered with Miracloth and the formulations dried in vacuum oven at 60 degrees overnight, and powdered.

### Example 4

### Demonstration that Free Herbicide is Not Required for Striga Control

Slow release formulations of herbicide were prepared as in Example 3 and applied without adding free herbicide using the methodology described in Example 2.

The results (Table 2) demonstrate that the lowest rate of slow release formulant provided adequate weed control, slightly better than the unformulated material.

TABLE 2
Effect of slow release formulations (not containing free herbicide) on
Striga control - field experiment - Short Rains 2002

| Imazapyr | | Striga emergence |
|---|---|---|
| (mg/seed) | Formulations | (m⁻²) at 12 weeks |
| 0 | — | 16.3 |
| 0.25 | — | 2.1 |
| 0.15 | DE-52 | 0 |
| 0.15 | DX-1 | 0.6 |
| 0.5 | — | 0.7 |
| 0.3 | DE-52 | 0.9 |
| 0.3 | DX-11 | 2.7 |

DE-52—Whatman DEAE-cellulose DE-52 as the ionic binder
DX-1—Dow Dowex 1 as the ionic binder

### Example 5

### Demonstration that Herbicidal Activity Not Lost by Leaching with Slow Release Formulations

Formulations were prepared as outlined in Example 3 and applied to the seeds, without adding free imazapyr (as in Example 2) and planted in pots. 63 pots (10,380 cm³) were set up, each with 8 kg soil (classified as a vetro-eutic planosol according to the FAO/UNESCO (1974) system) so that we had 21 pots per replication. Each pot was inoculated with 3,000 Striga and mixed thoroughly at a depth of 15 cm. The pots were watered and left for one week to allow Striga seeds to “pre-condition” for germination.

Two IR-corn seeds were planted in each plot, each treated 0, 0.25, 0.5 acid equivalent mg imazapyr per pot, as the free acid of the herbicide, or in 0, 0.15, 0.3, acid equivalent mg imazapyr per pot DE-52 or Dowex 1 formulations. Each formulation treatment at each rate had three replicates at each simulated rainfall regime. Natural rain measurements were made. Rainfall was supplemented at 19, 28, and 56 mm of water applied twice weekly, less amount of natural rainfall, for three months to simulate seasonal rainfalls of 500, 750 and 1500 mm, respectively. Measurements of Striga emergence were made at biweekly intervals. Late season emergence of Striga was measured at 12 weeks after planting. In all cases the slow release formulation gave superior Striga control, which was most evident at the lower rates of herbicide (Table 3). At the medium and highest watering level, there was no control of Striga by the lowest free herbicide rates, whereas the slow release herbicide performed far better (Table 3). This demonstrates that the slow release formulation allows using less herbicide and will give season long activity, even with the highest rainfalls.

TABLE 3
Effect of watering regimes on efficacy of slow release formulations
(pot experiments, Kenya)

| | | |
|---|---|---|
| | | Late season Striga |
| Imazapyr | | emergence 12 weeks |
| (mg/seed) | Formulation | (plants/m²) |

Low water (500 mm total)

| | | |
|---|---|---|
| 0 | — | 22 |
| 0.25 | — | 16 |
| 0.15 | DE-52 | 8 |
| 0.15 | DX-1 | 0.3 |
| 0.5 | — | 3 |
| 0.3 | DE-52 | 7 |
| 0.3 | DX-1 | 0 |

Medium water (750 mm total)

| | | |
|---|---|---|
| 0 | — | 36 |
| 0.25 | — | 33 |
| 0.15 | DE-52 | 3 |
| 0.15 | DX-1 | 1 |
| 0.5 | — | 7 |
| 0.3 | DE-52 | 6 |
| 0.3 | DX-1 | 1 |

High water (1500 mm total)

| | | |
|---|---|---|
| 0 | 0 | 60 |
| 0.25 | — | 57 |
| 0.15 | DE-52 | 27 |
| 0.15 | DX-1 | 24 |
| 0.5 | — | 11 |
| 0.3 | DE-52 | 8 |
| 0.3 | DX-1 | 9 |

### Example 6

### Synthesizing Slow Release Formulations of Imazapyr and Pyrithiobac Bound Covalently to Starch and Dextrans for ALS Resistant Mutant Maize

### Example 7

### Synthesizing Slow Release for ALS Resistant Mutant Maize with Slow Release Formulations of Imazapyr and Pyrithiobac Bound Covalently to Cellulose

### Example 8

Modifying cellulose ionic and covalent bound formulations (examples 1, 3 and 6 to further slow biological release by decreasing the rate of cellulolytic degradation by artificial lignification of the cellulose. The cellulose will be artificially lignified by first adsorbing peroxidase to the fibers and then reacting the material with eugenol and hydrogen peroxide, basically as described, in Gressel, J., Y. Vered, S. Bar-Lev, O. Milstein and H. M. Flowers. 1983 Partial suppression of cellulase action by artificial lignification of cellulose. Plant Sci. Lett., 32:349-353.

### Example 9

Coating maize seeds with slow release formulations. The efficacy of the formulations is demonstrated after coating maize seeds in field trials similar to those described in examples 2, 4.

### Example 10

### The Utility of Slow Release Formulations of Imazapyr and other General Herbicides for Non-Selective Weed Control

Non-selective, soil-active, rapidly leaching herbicides such as imazapyr and sulfometuron methyl are bound to ionic and slow release matrices as described above and used to treat orchards, industrial sites and rights-of way, demonstrating their lack of leaching and continued soil activity.

### References Cited

U.S. Patents

U.S. Pat No. 6,096,686 August, 2000 Gressel and Joel 504/100; 504/206

### Other Documents

Abayo, G. O., English, T., Eplee, R. E., Kanampiu, F. K., et al (1998), “Control of parasitic withcwees (Striga, spp.) on corn (Zea mays) resistant to acetolactate synthase inhibitors”, Weed Science, 46, 459-466.

Anand, V., Kandarapu, R. and Garg, S. (2001) ‘Ion-exchange resins: carrying drug delivery forward’, Drug Discovery Today, 6, 905-914.

Berner, D. K. et al., “Potential of imazaquin seed treatment for control of Striga gesnerioides and Alectra vogelii in cowpea (Vigna inguiculata).”, Plant Disease, vol. 8, No. 1, pp. 18-23 (1994).

Diaz, M. I., Bermello, J. C. and Napoles, M. N. (2001) ‘Synthesis and controlled release behavior of adducts dextran-2,4-dichlorophenoxyacetic chloride’, Latin American Applied Research, 31, 27-30.

Gressel, Jonathan., (1992). “The needs for new herbicide-resistant crops.”, In: Achievements and Developments in Combating Pesticide Resistance, Denholm, I., A. L. Devonshire and D. W. Hollomon, eds. Elsevier, London pp. 283-294

Gressel, J. and Joel, D. M. (2000) ‘Use of glyphosate salts in seed dressing herbicidal compositions’, U.S. Pat. No. 6,096,686.

Jagtap, H. S., Gupte, M. Y., Sukumar, K. and Das, K. G. (1983) ‘Controlled release pesticides 1: a terrestrial herbicide’, International Pest Control, 25, 142-145.

Joel, Daniel M. et al., “Transgenic crops against parasites.”, Nature, vol. 374, pp. 220-221 (1995).

Kanampiu, F. K., Ransom, J. K. and Gressel, J. (2001) ‘Imazapyr seed dressings for Striga control on acetolactate synthase target-site resistant maize’, Crop Protection, 20, 885-895.

Kanampiu, F. K., Ransom, J. K., Friesen, D. and Gressel, J. (2002) ‘Imazapyr and pyrithiobac movement in soil and from maize seed coats controls Striga in legume intercropping’, Crop Protection, 21:611-619.

Kanampiu, F. K., V. Kabambe, C. Massawe, L. Jasi, J. K. Ransom, D. Friesen, and J. Gressel. (2003) Multisite, multi-season field tests demonstrate that herbicide seed-coating herbicide-resistance maize controls Striga spp. and increases yields. Crop Protection 22 (in press)

Lewis, D. H. and Cowsar, D. R. (1977) ‘Principles of controlled release pesticides’, in Scher, H. B., ed. Controlled Release Pesticides, Washington D.C.: American Chemical Society, pp. 1-6.

Mehltretter, C. L., Roth, W. B., Weakley, F. B., McGuire, T. A., et al. (1974) ‘Potential controlled-release herbicides from 2,4-D esters of starches’, Weed Science, 22, 415-418.

Mishael, Y. G., Undabeytia, T., Rytwo, G., Papahadjopoulos-Stemberg, B., Rubin, B., Nir, S., (2002a) Sulfometuron incorporation in cationic micelles adsorbed on montmorillonite Journal of Agricultural and Food Chemistry, 50, 2856-2863.

Mishael, Y. G., Undabeytia, T., Rabinovitz, O., Rubin, B., Nir, S. (2002b) Slow-release formulations of sulfometuron incorporated in micelles adsorbed on montmorillonite Journal of Agricultural and Food Chemistry 50, 2864-2869.

Patwardhan, S. A. and Das, K. G. (1983) ‘Chemical Methods of Controlled Release’, in Das, K. G., ed. Controlled Release Technology, Bioengineering Aspects., New York, N.Y.: Wiley, pp.

Schreiber, M. M., Shasha, B. S., Trimnell, D. and White, M. D. (1987) ‘Methods of Applying Herbicides’, in McWhorter, C. G. and Gebhardt, M. R., eds., Controlled Release Herbicides, Champaign, Ill.: Weed Science Society of America, pp. 177-191.

Tefft, J. and Friend, D. R. (1993) ‘Controlled-release herbicide formulations based on polymeric microspheres’, Journal of Controlled Release, 27, 27-35.

All patents, patent applications, and published references cited herein are hereby incorporated by reference in their entirety. While this invention has been particularly shown and described with references to preferred embodiments thereof, it will be understood by those skilled in the art that various changes in form and details may be made therein without departing from the scope of the invention encompassed by the appended claims.

1. A slow-releasing agrochemical dispenser, comprising:
a. a particle of about 1 mm in diameter to about 1 cm in diameter; with,
b. a surface coating of a slow-release agrochemical adsorbed to the particle.

2. A slow-release agrochemical dispenser as in claim 1, further comprising a particle made of a strong ion exchange resin.

3. An agrochemical dispenser as in claim 1, further comprising a particle made of a weak ion exchange resin.

4. An agrochemical dispenser as in claim 1, further comprising an artificially lignified cellulose particle.

5. An agrochemical dispenser as in claim 1, further comprising a particle made of starch.

6. An agrochemical dispenser as in claim 1, further comprising a particle made of cellulose.

7. An agrochemical dispenser as in claim 1, further comprising a particle made of dextran.

8. An agrochemical dispenser as in claim 1 wherein the slow-release agrochemical is covalently attached to the particle.

9. A slow-releasing agrochemical dispenser, comprising:
a. A plant seed, with,
b. A surface coating of a slow-release agrochemical adsorbed to the surface of the seed.

10. An agrochemical dispenser as in claim 9, wherein the plant seed is a seed of a vegetable, legume, or cereal.

11. An agrochemical dispenser as in claim 10, wherein the seed of a vegetable, legume or cereal is from a mutant or transgenic plant resistant to acetolactate synthase (ALS) inhibitors.

12. An agrochemical dispenser as in claim 11, wherein the acetolactate synthase inhibitor is imazapyr.

13. An agrochemical dispenser as in claim 11, wherein the acetolactate synthase inhibitor is pyrithiobac.

14. A slow releasing agrochemical dispenser as in claim 1 or 9, wherein the surface coating of a slow-release agrochemical contains polyvinylpyrollidone (PVP) (average MW 90 Kd) at a rate of about 90% wt/vol.

15. An agrochemical dispenser as in claim 1 or 9, wherein the slow-release agrochemical is a herbicide formulation.

16. An agrochemical dispenser as in claim 1 or 9, wherein the slow-release agrochemical forms a non-covalent interaction with the particle.

17. An agrochemical dispenser as in claim 1 or 9, wherein the slow-release agrochemical is an acetolactate synthase (ALS) inhibitor.

18. An agrochemical dispenser as in claim 16, wherein the slow-release agrochemical is a herbicide.

19. An agrochemical dispenser as in claim 15, wherein the slow-release agrochemical is an acetolactate synthase (ALS) inhibitor

20. An agrochemical dispenser as in claim 18, wherein the slow-release agrochemical is an acetolactate synthase (ALS) inhibitor.

21. An agrochemical dispenser as in claim 17, wherein the ALS inhibitor is imazapyr.

22. An agrochemical dispenser as in claim 19, wherein the ALS inhibitor is imazapyr.

23. An agrochemical dispenser as in claim 20, wherein the ALS inhibitor is imazapyr.

24. An agrochemical dispenser as in claim 17, wherein the ALS inhibitor is pyrithiobac.

25. An agrochemical dispenser as in claim 19, wherein the ALS inhibitor is pyrithiobac.

26. An agrochemical dispenser as in claim 20, wherein the ALS inhibitor is pyrithiobac.

27. A slow-releasing agrochemical dispenser as in claim 1 or 9, wherein the slow-release agrochemical is in the form of water soluble microspheres, where said microspheres enclose a herbicide.

28. A slow-releasing agrochemical dispenser, comprising:
a. a particle made of a strong anionic exchange resin of about 1 mm in diameter to about 1 cm in diameter; with,
b. a surface coating of a slow-release formulation of imazapyr.

29. A slow-releasing agrochemical dispenser, comprising:
a. a particle made of a weak anionic exchange resin of about 1 mm in diameter to about 1 cm in diameter; with,
b. a surface coating of a slow-release formulation of imazapyr.

30. A slow releasing agrochemical dispenser, as in claim 28 or 29, wherein half of the slow-release formulation of imazapyr is bound covalently to the particle and half is adsorbed as a free salt.

31. A slow-releasing agrochemical dispenser, comprising:
at a particle made of a strong anionic exchange resin of about 1 mm in diameter to about 1 cm in diameter; with,
b. a surface coating of a slow-release formulation of pyrithiobac.

32. A slow-releasing agrochemical dispenser, comprising:
a. a particle made of a weak anionic exchange resin of about 1 mm in diameter to about 1 cm in diameter; with,
b. a surface coating of a slow-release formulation of pyrithiobac.

33. A slow releasing agrochemical dispenser, as in claim 31 or 32, wherein half of the slow-release formulation of pyrithiobac is bound covalently to the particle and half is adsorbed as a free salt.

34. A slow-releasing agrochemical dispenser, comprising:
a. a cellulose particle of about 1 mm in diameter to about 1 cm in diameter; with,
b. a covalently linked surface coating of a slow-release agrochemical adsorbed to the surface of the particle.

35. A slow-releasing agrochemical dispenser, as in claim 34, further comprising a particle made of artificially lignified cellulose.

36. A slow-releasing agrochemical dispenser, as in claim 34 or 35, further comprising a coating formulation of 1 part imazapyr and 1 part pyrithiobac.

37. An agrochemical dispenser as in claim 34, wherein the agrochemical is a herbicide.

38. A slow-release agrochemical dispenser as in any one of claims 2, 28, or 31, wherein the strong ion exchange resin is Dowex 2 anion exchange resin.

39. An agrochemical dispenser as in any one of claims 3, 29, or 32, wherein the weak ion exchange resin is DEAE cellulose.

40. An agrochemical dispenser as in claim 5, wherein the starch is a chemically modified.

41. An agrochemical dispenser as in claim 6, wherein the cellulose is chemically modified.

42. An agrochemical dispenser as in claim 7, wherein the dextran is chemically-modified.

43. A method of treating weeds or crops so as to prevent weeds comprising planting an effective number of the composition of claim 9 in an agricultural field.

44. A method of treating weeds or crops so as to prevent weeds comprising planting an effective number of the composition of claim 10 in an agricultural field.

45. A method of treating weeds or crops so as to prevent weeds comprising planting an effective number of the composition of claim 11 in an agricultural field.

46. A method of treating weeds or crops so as to prevent weeds comprising planting an effective number of the composition of claim 13 in an agricultural field.

47. A method of treating weeds or crops so as to prevent weeds comprising planting an effective number of the composition of claim 14 in an agricultural field.

48. A method of treating weeds or crops so as to prevent weeds comprising planting an effective number of the composition of claim 15 in an agricultural field.

49. A method of treating weeds or crops so as to prevent weeds comprising planting an effective number of the composition of claim 17 in an agricultural field.

50. A method of treating weeds or crops so as to prevent weeds comprising planting an effective number of the composition of claim 18 in an agricultural field.

51. A method of treating weeds or crops so as to prevent weeds comprising planting an effective number of the composition of claim 19 in an agricultural field.

52. A method of treating weeds or crops so as to prevent weeds comprising planting an effective number of the composition of claim 20 in an agricultural field.

53. A method of treating weeds or crops so as to prevent weeds comprising planting an effective number of the composition of claim 21 in an agricultural field.

54. A method of treating weeds or crops so as to prevent weeds comprising planting an effective number of the composition of claim 22 in an agricultural field.

55. A method of treating weeds or crops so as to prevent weeds comprising planting an effective number of the composition of claim 23 in an agricultural field.

56. A method of treating weeds or crops so as to prevent weeds comprising planting an effective number of the composition of claim 24 in an agricultural field.

57. A method of treating weeds or crops so as to prevent weeds comprising planting an effective number of the composition of claim 25 in an agricultural field.

58. A method of treating weeds or crops so as to prevent weeds comprising planting an effective number of the composition of claim 26 in an agricultural field.

59. A method of treating weeds or crops so as to prevent weeds comprising planting an effective number of the composition of claim 27 in an agricultural field.

60. A slow-releasing agrochemical dispenser, comprising:
a. a dextran particle of about 1 mm in diameter to about 1 cm in diameter, with;
b. a covalently linked surface coating.

61. A slow-releasing agrochemcial dispenser as in claim 60, wherein the dextran is chemically modified.

62. A slow-releasing agrochemcial dispenser, comprising:
a. a starch particle of about 1 mm in diameter to about 1 cm in diameter, with;
b. a covalently linked surface coating.

63. A slow-releasing agrochemical dispenser as in claim 62, wherein the starch is chemically modified.

64. A slow releasing agrochemical dispenser wherein the agrochemical is toxic to a plant and this toxicity is mitigated when the agrochemical is released slowly at a low dose, comprising:
a. a plant seed, with
b. an adsorbed surface coating of a slow release agrochemical formulation.

65. A slow releasing agrochemical dispenser as in claim 64, wherein the agrochemical is a herbicide.

66. A method for dispensing slow-release agrochemicals comprising sequentially the steps of:
a. contacting a particle with a slow-release formulation agrochemical,
b. coating the particle with the agrochemical,
c. optionally drying the coated particle, and
d. placing the coated particle in soil, in situ.

67. The method of claim 66, wherein the particle is a plant seed.

68. The method of claim 66, wherein the agrochemical is a general non-selective herbicide.

69. The methods of claim 66, wherein the herbicide is potentially phytotoxic to an agricultural crop in normal doses, but not at levels achieved by slow-release formulations

70. The method of claim 66, wherein the soil is in a field suitable for planting agricultural crops.

71. The method of claim 66, further comprising a particle made of artificially lignified cellulose.

72. A method for controlling parasitic weeds comprising, sequentially the steps of:
a. contacting a particle with a slow-release formulation herbicide,
b. binding the herbicide to the particle,
c. optionally drying the coated particle, and
d. placing an effective number of coated particles in soil, in situ, where weeds might be a problem.

73. The method of claim 72, wherein the particle is a plant seed.

74. The method of claim 73, wherein the soil is in a field suitable for planting agricultural crops.
